(19) United States
(12) Patent Application Publication
(10) Pub. No.: US 2023/0334377 A1
(43) Pub. Date: Oct. 19, 2023

(54) DATA PROCESSING DEVICE, DATA PROCESSING SYSTEM, AND DATA PROCESSING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Ryo OSAMURA, Kawasaki (JP); Naoyuki NARITA, Funabashi (JP); Tomoyuki MAEDA, Kawasaki (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/159,759

(22) Filed: Jan. 26, 2023

(30) Foreign Application Priority Data
Apr. 19, 2022 (JP) 2022-068632

(51) Int. Cl. G06N 20/10

(52) U.S. Cl. CPC G06N 20/10

(57) ABSTRACT

According to one embodiment, a data processing device includes a processor. The processor is configured to generate a first machine learning model based on a first generated data based on the first acquired data and a first other acquired data in the first operation. The first other data includes a first other feature value matrix with Np rows and D1 columns and a first other label with Np rows. The Np is an integer of 2 or more. The D1 is an integer of 1 or more. The first acquired data includes a first feature value matrix with N1 rows and D1 columns and a first acquired label with N1 rows. The first generated data includes a first generated matrix with (Np+N1) rows and (3×D1) columns and a first generated label with (Np+N1) rows. (Np+N1)/D1 is 250 or more.

### CROSS-REFERENCE TO RELATED APPLICATIONS

This application is based upon and claims the benefit of priority from Japanese Patent Application No. 2022-068632, filed on Apr. 19, 2022; the entire contents of which are incorporated herein by reference.

### FIELD

Embodiments described herein relate generally to a data processing device, a data processing system, and a data processing method.

### BACKGROUND

For example, data relating to various electronic devices such as magnetic recording/reproducing devices are processed. For example, machine learning is performed by data processing. Highly accurate data processing is desired.

### BRIEF DESCRIPTION OF THE DRAWINGS

FIG. 1 is a schematic view illustrating a data processing device according to a first embodiment;

FIG. 2 is a schematic view illustrating the operation of the data processing device according to the first embodiment;

FIG. 3 is a schematic view illustrating the operation of the data processing device according to the first embodiment;

FIG. 4 is a schematic view illustrating the operation of the data processing device according to the first embodiment;

FIG. 5 is a schematic view illustrating the operation of the data processing device according to the first embodiment;

FIG. 6 is a schematic view illustrating the operation of the data processing device according to the first embodiment;

FIG. 7 is a schematic view illustrating the operation of the data processing device according to the first embodiment;

FIG. 8 is a schematic view illustrating the operation of the data processing device according to the first embodiment;

FIG. 9 is a schematic view illustrating the operation of the data processing device according to the first embodiment;

FIG. 10 is a schematic view illustrating the operation of the data processing device according to the first embodiment;

FIG. 11 is a schematic view illustrating the operation of the data processing device according to the first embodiment;

FIG. 12 is a schematic view illustrating the operation of the data processing device according to the first embodiment;

FIG. 13 is a schematic view illustrating the operation of the data processing device according to the first embodiment;

FIG. 14 is a schematic view illustrating the operation of the data processing device according to the first embodiment;

FIG. 15 is a schematic view illustrating the operation of the data processing device according to the first embodiment;

FIG. 16 is a schematic view illustrating the operation of the data processing device according to the first embodiment;

FIG. 17 is a graph illustrating characteristics of the data processing device according to the first embodiment; and

FIG. 18 is a schematic view illustrating the data processing device according to the embodiment.

### DETAILED DESCRIPTION

According to one embodiment, a data processing device includes an acquisitor, and a processor. The acquisitor is configured to acquire first acquired data in a first operation. The processor is configured to generate a first machine learning model based on a first generated data based on the first acquired data and a first other acquired data in the first operation. The first other data includes a first other feature value matrix with Np rows and D1 columns and a first other label with Np rows. The Np is an integer of 2 or more. The D1 is an integer of 1 or more. The first acquired data includes a first feature value matrix with N1 rows and D1 columns and a first acquired label with N1 rows. The N1 is an integer of 2 or more. The N1 is smaller than the Np. The first generated data includes a first generated matrix with (Np+N1) rows and (3×D1) columns and a first generated label with (Np+N1) rows. The first generated matrix includes first matrix data, second matrix data, and third matrix data. Components of the first matrix data include combinations in a row direction of the first other feature value matrix and the first feature value matrix. Components of the second matrix data include combinations in the row direction of a matrix of 0 components with Np rows and D1 columns and the first feature value matrix. Components of the third matrix data include combinations in the row direction of the first other feature value matrix and a matrix of 0 components with N1 rows and D1 columns. Components of the first generated label include combinations in the row direction of the first other label and the first acquired label. (Np+N1)/D1 is 250 or more.

Various embodiments are described below with reference to the accompanying drawings.

The drawings are schematic and conceptual. In the specification and drawings, components similar to those described previously or illustrated in an antecedent drawing are marked with like reference numerals, and a detailed description is omitted as appropriate.

### First Embodiment

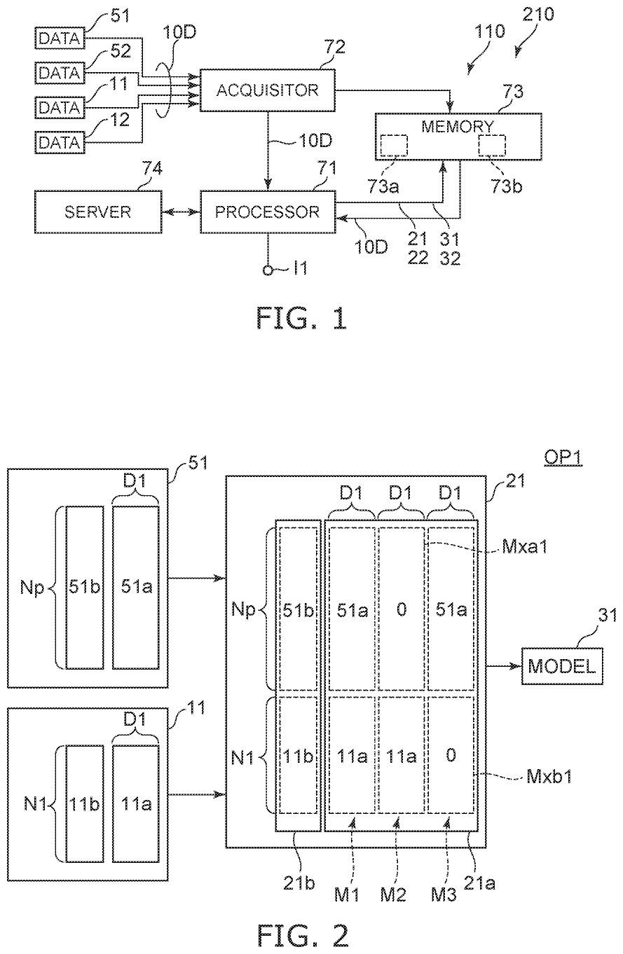

FIG. 1 is a schematic view illustrating a data processing device according to a first embodiment.

As shown in FIG. 1, the data processing device 110 according to the embodiment includes a processor 71. The processor 71 can acquire various data 10D. For example, data processing device 110 may include an acquisitor 72. The acquisitor 72 may acquire various data 10D and the data 10D acquired by the acquisitor 72 may be supplied to the processor 71. The data processing device 110 may include a memory 73. The data 10D acquired by the acquisitor 72 may be stored in the memory 73. The processor 71 may acquire the data 10D stored in the memory 73 from the memory 73.

The acquisitor 72 is, for example, an interface. The acquisitor 72 may be, for example, an interface for input and output. The processor 71 may output information I1 on the processed result. The information I1 may be output via the acquisitor 72 (interface). The processor 71 may be able to communicate with a server 74. The communication may include at least one of providing information or obtaining information. The communication may be based on any method, wired or wireless.

The data 10D may include, for example, acquired data (e.g., first acquired data 11 and second acquired data 12, etc.). The data 10D may include other data (ego, first other data 51 and second other data 52, etc.).

FIG. 2 is a schematic view illustrating the operation of the data processing device according to the first embodiment.

In the embodiment, the acquisitor 72 and the processor 71 can perform the first operation OP1. The acquisitor 72 can obtain the first acquired data 11 in the first operation OP1. The processor 71 may acquire the first acquired data 11 from the acquisitor 72. The processor 71 may acquire the first acquired data 11 stored in the memory 73.

The processor 71 acquires the first other data 51. For example, the acquisitor 72 may acquire the first other data 51 and the processor 71 may acquire the first other data 51 from the acquisitor 72. The processor 71 may acquire the first other data 51 stored in the memory 73.

The processor 71 can generate a first machine learning model 31 based on a first generated data 21 based on the first acquired data 11 and the first other data 51 in the first operation OP1.

The first other data 51 includes a first other feature value matrix 51a with Np rows and D1 columns and a first other label 51b with Np rows. “Np” is an integer of 2 or more. The first other label 51b corresponds to the first other feature value matrix 51a. “Np” corresponds to the number of samples in the first other data 51, for example.

The first acquired data 11 includes a first feature value matrix 11a with N1 rows and D1 columns and a first acquired label 11b with N1 rows. “N1” is an integer of 2 or more. “D1” is an integer of 1 or more. “N1” is smaller than “Np”. “N1” corresponds to the number of samples in the first acquired data 11, for example.

In one example, the first acquired data 11 is small-scale data about the target device. The first other data 51 is large-scale data relating to at least one of the target device and devices similar to the target device. For example, the first acquired data 11 relates to evaluation data for small-scale experiments. For example, the first other data 51 relates to evaluation data relating to mass-produced products.

In one example, the target device is a magnetic recording/reproducing device. The first acquired data 11 relates to data relating to a prototype of the magnetic recording/reproducing device. The first other data 51 relates to data relating to mass-produced magnetic recording/reproducing devices.

The processor 71 can generate the first generated data 21 based on the first acquired data 11 and the first other data 51 as described above. As shown in FIG. 2, the first generated data 21 includes a first generated matrix 21a and a first generated label 21b. The first generated matrix 21a is a matrix of (Np+N1) rows and (3×D1) columns. The first generated label 21b is data of the (Np+N1) rows. The number of columns of the first generated label 21b is 1, for example.

The first generated matrix 21a includes first matrix data M1, second matrix data M2 and third matrix data M3.

The components of the first matrix data M1 include combinations in the row direction of the first other feature value matrix 51a and the first feature value matrix 11a.

The components of the second matrix data M2 include combinations in the row direction of a matrix Mxa1 (that is, 0 matrix) of 0 components with Np rows and D1 columns and the first feature value matrix 11a.

The components of the third matrix data M3 include combinations in the row direction of the first other feature value matrix 51a and a matrix Mxb1 of 0 components with N1 rows and D1 columns (that is, 0 matrix).

The components of the first generated label 21b include the combinations in the row direction of the first other label 51b and the first acquired label 11b.

In the embodiment, (Np+N1)/D1 is, for example, 250 or more. (Np+N1)/D1 is defined a first ratio R1. As will be described later, in the embodiment, the first ratio R1 may be 500 or more.

In the embodiment, such first generated data 21 is generated. The first machine learning model 31 is generated based on the first generated data 21. High-precision data processing becomes possible in the first machine learning model 31.

For example, in the embodiment transfer learning is performed. In the transfer learning according to the embodiment, for example, the first generated data 21 is derived by combining the first acquired data 11 (target data) with the first other data 51. A machine learning model based on such first generated data 21 is used. This provides higher accuracy than the first reference example, which uses a machine learning model based only on the target data.

As will be described later, when the first ratio R1 (that is, (Np+N1)/D1) is 250 or more, higher accuracy than in the first reference example is obtained. An example of the relationship between the first ratio R1 and accuracy will be described later.

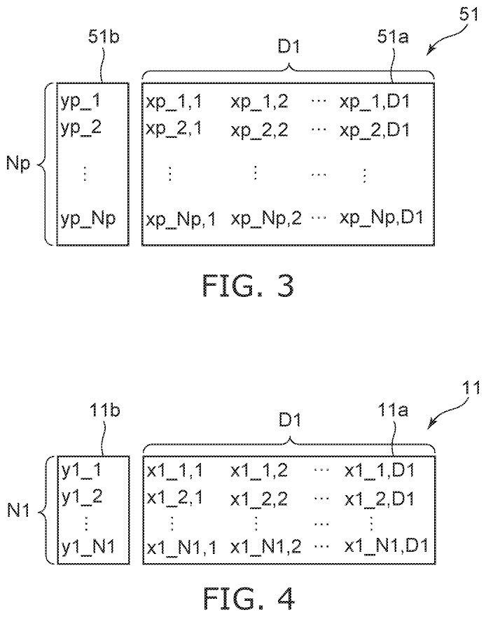

FIGS. 3 to 5 are schematic views illustrating the operation of the data processing device according to the first embodiment.

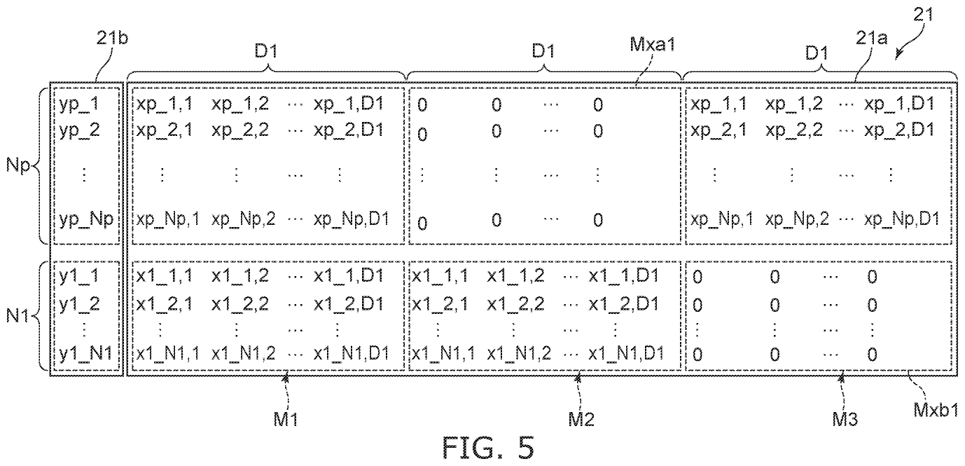

FIG. 3 illustrates the first other data 51. FIG. 4 illustrates the first acquired data 11. FIG. 5 illustrates the first generated data 21.

As shown in FIG. 3, the first other data 51 includes of first other labels 51b with Np rows. The first other label 51b includes, for example, yp_1; yp_2; . . . yp_Np. The first other data 51 includes the first other feature value matrix 51a with Np rows and D1 columns. The first row of the first other feature value matrix 51a includes, for example, xp_1,1; xp_1,2; . . . xp_1,D1. The second row of the first other feature value matrix 51a includes, for example, xp_24; xp_2,2; . . . xp_2,D1. The Np-th row of the first other feature value matrix 51a includes, for example, xp_Np,1; xp_Np,2; . . . xp_Np,D1.

As shown in FIG. 4, the first acquired data 11 includes the first acquired labels 11b with N1 rows. The first acquired label 11b includes, for example, y1_1; y1_2; . . . y1_N1. The first acquired data 11 includes the first feature value matrix 11a with N1 rows and D1 columns. The first row of the first feature value matrix 11a includes, for example, x1_14; x1_1,2; . . . x1_1,D1. The second row of the first feature value matrix 11a includes, for example, x1_24; x1_2,2; . . . x1_2,D1. The N1-th row of the first feature value matrix 11a includes, for example, x1_N1,1; x1_N1,2; . . . x1_N1,D1.

As shown in FIG. 5, the first generated data 21 includes the first generated label 21b with (Np+N1) rows. The first generated label 21b includes yp_1; yp_2; . . . yp_Np; y1_1; y1_2; . . . y1_N1, for example.

The first generated data 21 includes the first generated matrix 21a with (Np+N1) rows and (3×D1) columns.

The first row of the first generated matrix 21a includes, for example, xp_14; xp_1,2; . . . xp_1,D1; D1 “0” s; xp_14; xp_1,2; . . . xp_1,D1. The second row of the first generated matrix 21a includes, for example, xp_24; xp_2,2; . . . xp_2,D1; D1 “0” s; xp_24; xp_2,2; . . . xp_2,D. The Np-th row of the first generated matrix 21a includes, for example, xp_Np,1; xp_Np,2; . . . xp_Np,D1; D1 “0” s; xp_Np,1; xp_Np,2; . . . xp_Np,D1.

The (Np+1)-th row of the first generated matrix 21a includes, for example, x1_14; x1_1,2; . . . x1_1,D1; x1_14; x1_1,2; . . . x1_1,D1; D1 “0” s. The (Np+2)-th row of the first generated matrix 21a includes, for example, x1_24; x1_2,2; . . . x1_2,D1; x1_24; x1_2,2; . . . x1_2,D1; D1 “0” s. The (Np+N1)-th row of the first generated matrix 21a includes, for example, x1_N1,1; x1_N1,2; . . . x1_N1,D1; x1_N1,1; x1_N1,2; . . . x1_N1, D1; D1 “0” s.

The first machine learning model 31 is generated based on such first generated data 21. For example, the processor 71 generates the first machine learning model 31 from at least one selected from the group consisting of kernel regression, linear regression, Ridge regression, Lasso regression, Elastic Net, gradient boosting regression, random forest regression, k-nearest neighbor regression, and logistic regression.

Kernel regression may include at least one of Gaussian process regression or SVR (Support Vector Regression), for example.

As shown in FIG. 1, in the embodiment, the memory 73 may include a first memory area 73a and a second memory area 73b. For example, the first acquired data 11 acquired by the acquisitor 72 is stored in the first memory area 73a. For example, the first other data 51 may be stored in the first memory area 73a. The processor 71 may acquire the first acquired data 11 and the first other data 51 from the first memory area 73a and perform the first operation OP1.

As shown in FIG. 1, the memory 73 may include the second memory area 73b. The processor 71 may be able to store the generated first generated data 21 in the second memory area 73b. The processor 71 may be able to store the derived first machine learning model 31 in the second memory area 73b.

The processor 71 may be able to further perform the following processing in the first operation OP1.

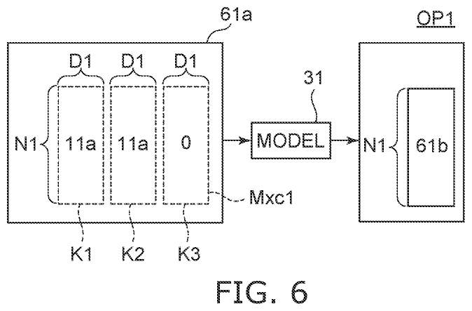

FIG. 6 is a schematic view illustrating the operation of the data processing device according to the first embodiment.

As shown in FIG. 6, the processor 71 can further derive a first regression label 61b by inputting a first regression matrix 61a to the first machine learning model 31 in the first operation OP1.

The first regression matrix 61a has N1 rows and (3×D1) columns. The first regression matrix 61a includes first regression matrix data K1, second regression matrix data K2 and third regression matrix data K3. The components of the first regression matrix data K1 include the first feature value matrix 11a. The components of the second regression matrix data K2 include the first feature value matrix 11a. The components of the third regression matrix data K3 include a matrix Mxc1 (that is, 0 matrix) of 0 components with N1 rows and D1 columns. The first regression label 61b derived has N1 rows.

High accuracy is obtained in the first regression label 61b thus obtained. For example, in the first reference example described above, the machine learning model based on the first acquired data 11 (target data) is used. In the first reference example, the accuracy of regression labels obtained using this machine learning model is low. In the embodiment, the first regression label 61b with higher precision than the first reference example is obtained.

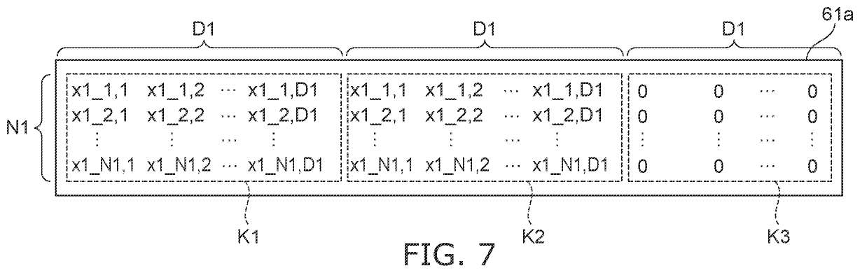

FIG. 7 is a schematic view illustrating the operation of the data processing device according to the first embodiment.

FIG. 7 illustrates the first regression matrix 61a. The first row of the first regression matrix 61a includes, for example, x1_14; x1_1,2; . . . x1_1,D1; x1_14; x1_1,2; . . . x1_1,D1; D1 “0” s. The second row of the first regression matrix 61a includes, for example, x1_24; x1_2,2: . . . x1_2,D1; x1_24; x1_2,D1; D1 “0” s.

The N1-th row of the first regression matrix 61a includes, for example, x1_N1,1; x1_N1,2; . . . x1_N1,D1; x1_N1,1; x1_N1,2 . . . x1_N1,D1; D1 “0” s. Such a first regression matrix 61a is input to the first machine learning model 31 to obtain the first regression label 61b.

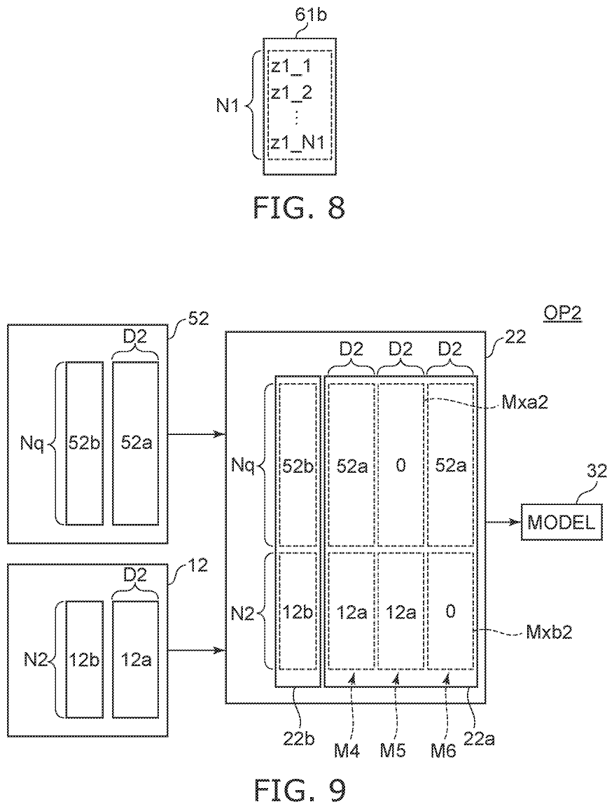

FIG. 8 is a schematic view illustrating the operation of the data processing device according to the first embodiment.

FIG. 8 illustrates the first regression label 61b. As shown in FIG. 8, the first regression label 61b includes, for example, z1_1; z1_2; . . . z1_N1. Such a first regression label 61b has high accuracy.

As described below, the acquisitor 72 and the processor 71 may be able to perform the second operation.

FIG. 9 is a schematic view illustrating the operation of the data processing device according to the first embodiment.

In the embodiment, the acquisitor 72 and the processor 71 can perform the second operation OP2. The acquisitor 72 can obtain the second acquired data 12 in the second operation OP2. The processor 71 may acquire the second acquired data 12 from the acquisitor 72. The processor 71 may acquire the second acquired data 12 stored in the memory 73.

The processor 71 acquires the second other data 52. For example, the acquisitor 72 may acquire the second other data 52 and the processor 71 may acquire the second other data 52 from the acquisitor 72. The processor 71 may acquire the second other data 52 stored in the memory 73.

The processor 71 can generate a second machine learning model 32 based on a second generated data 22 based on the second acquired data 12 and the second other data 52 in the second operation OP2.

The second other data 52 includes a second other feature value matrix 52a with Nq rows and D2 columns and a second other label 52b with Nq rows. “Nq” is an integer of 2 or more. The second other label 52b corresponds to the second other feature value matrix 52a. “Nq” corresponds to the number of samples in the second other data 52, for example.

The second acquired data 12 includes a second feature value matrix 12a with N₂ rows and D2 columns and a second acquired label 12b with N₂ rows. “N2” is an integer of 2 or more. “D2” is an integer of 1 or more. “N2” is smaller than “Nq”. “N2” corresponds to the number of samples in the second acquired data 12, for example.

For example, the second acquired data 12 is small-scale data relating to the target device corresponding to the second acquired data 12. The second other data 52 is large-scale data relating to at least one of the target device or devices similar to the target device.

The processor 71 can generate the second generated data 22 based on the second acquired data 12 and the second other data 52 as described above. As shown in FIG. 9, the second generated data 22 includes a second generated matrix 22a and a second generated label 22b. The second generated matrix 22a is a matrix with (Nq+N2) rows and (3×D2) columns. The second generated label 22b is the data with the (Nq+N2) row. The number of columns of the second generated label 22b is 1, for example.

The second generated matrix 22a includes fourth matrix data M4, fifth matrix data M5 and sixth matrix data M6.

The components of the fourth matrix data M4 include combinations in the row direction of the second other feature value matrix 52a and the second feature value matrix 12a.

The components of the fifth matrix data M5 include combinations in the row direction of a matrix Mxa2 (that is, 0 matrix) of 0 components with Nq rows and D2 columns and the second feature value matrix 12a.

The components of the sixth matrix data M6 include combinations in the row direction of the second other feature value matrix 52a and a matrix Mxb2 of 0 components with N₂ rows and D2 columns (that is, 0 matrix).

The components of the second generated label 22b include combinations in the row direction of the second other label 52b and the second acquired label 12b.

In the second operation OP2, (Nq+N2)/D2 is, for example, 250 or more. This ratio may be 500 or more.

In the embodiment, such second generated data 22 is generated. The second machine learning model 32 is generated based on the second generated data 22. High-precision data processing becomes possible in the second machine learning model 32.

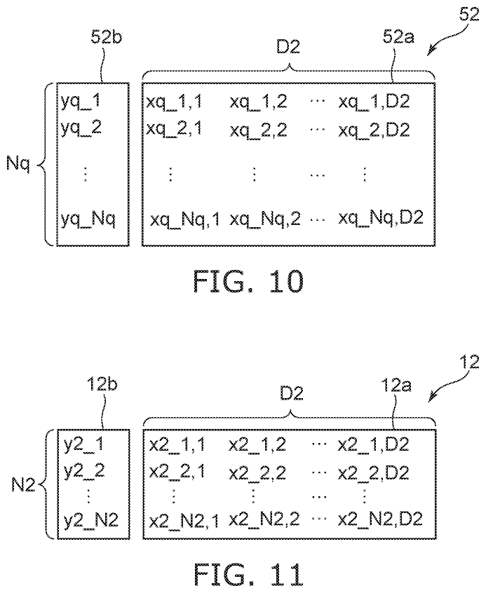

FIGS. 10 to 12 are schematic views illustrating the operation of the data processing device according to the first embodiment.

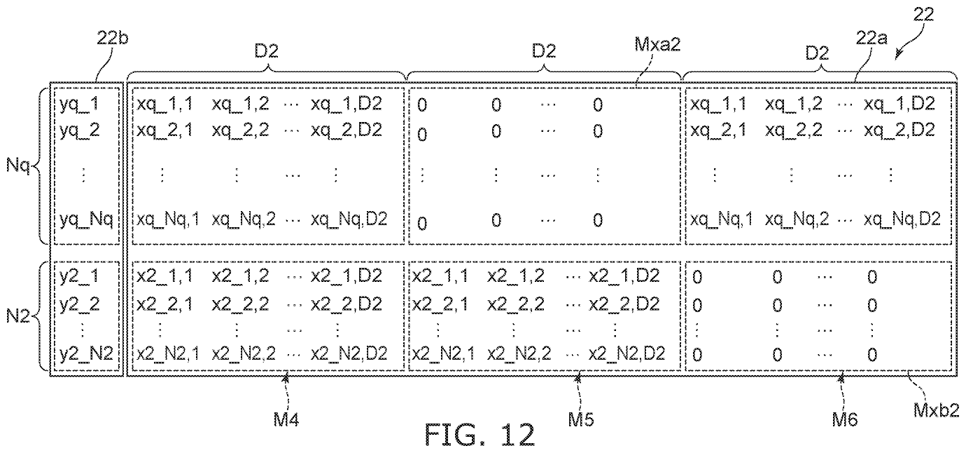

FIG. 10 illustrates the second other data 52. FIG. 11 illustrates the second acquired data 12. FIG. 12 illustrates the second generated data 22.

As shown in FIG. 10, the second other data 52 includes the second other label 52b of Nq rows. The second other label 52b includes, for example, yq_1; yq_2; . . . yq_Np. The second other data 52 includes a second other feature value matrix 52a with Nq rows and D2 columns. The first row of the second other feature value matrix 52a includes, for example, xq_1,1; xq_1,2; . . . xq_1,D2. The second row of the second other feature value matrix 52a includes, for example, xq_2,1; xq_2,2; . . . xq_2,D2. The Nq-th row of the second other feature value matrix 52a includes, for example, xq_Nq,1; xq_Nq,2; . . . xq_Nq,D2.

As shown in FIG. 11, the second acquired data 12 includes the second acquired labels 12b of N2 rows. The second acquired label 12b includes, for example, y2_1; y2_2; . . . y2_N2. The second acquired data 12 includes the second feature value matrix 12a with N₂ rows and D2 columns. The first row of the second feature value matrix 12a includes, for example, x2_14; x2_1,2; . . . x2_1,D2. The second row of the second feature value matrix 12a includes, for example, x2_2,1; x2_2,2; . . . x2_2,D2. The N2-th row of the second feature value matrix 12a includes, for example, x2_N2,1; x2_N2,2; . . . x2_N2,D2.

As shown in FIG. 12, the second generated data 22 includes the second generated label 22b of (Nq+N2) rows. The second generated label 22b includes, for example, yq_1; yq_2; . . . yq_Nq; y2_1; y2_2; . . . y2_N2.

The second generated data 22 includes the second generated matrix 22a with (Nq+N2) rows and (3×D2) columns.

The first row of the second generated matrix 22a includes, for example, xq_1,1; xq_1,2; . . . xq_1,D2; D2 “0” s; xq_1,1; xq_1,2; . . . xq_1,D2. The second row of the second generated matrix 22a includes, for example, xp_24; xp_2,2; . . . xp_2,D2; D2 “0”s; xq_2,1; xq_2,2; . . . xq_2,D2. The Nq row of the second generated matrix 22a includes, for example, xq_Np,1; xq_Np,2; . . . xq_Np,D2; D2 “0”s; xq_Nq,1; xq_Np,2; . . . xq_Nq,D2.

The (Nq+1)-th row of the second generated matrix 22a includes, for example, x2_14; x2_1,2; . . . x2_1, D2; x2_14; x2_1,2; . . . xq_2,D2; D2 “0”s. The (Nq+2)-th row of the second generated matrix 22a includes, for example, x2_24; x2_2,2; . . . x2_2,D2; x2_2,1; x2_2,2; . . . x2_2,D2; D2 “0”s. The (Nq+N2)-th row of the second generated matrix 22a includes, for example, x2_N2,1; x2_N2,2; . . . x2_N2,D2; x2_N2,1; x2_N2,2; . . . x2_N2,D2; D2 “0”s.

The second machine learning model 32 is generated based on such second generated data 22. The second machine learning model 32 may be generated in the same manner as the first machine learning model 31, for example.

The second acquired data 12 may be stored in the first memory area 73a. For example, the second other data 52 may be stored in the first memory area 73a. The processor 71 may acquire the second acquired data 12 and the second other data 52 from the first memory area 73a and perform the second operation OP2.

The processor 71 may be able to store the generated second generated data 22 in the second memory area 73b. The processor 71 may be able to store the derived second machine learning model 32 in the second memory area 73b.

The processor 71 may be able to further perform the following processing in the second operation OP2.

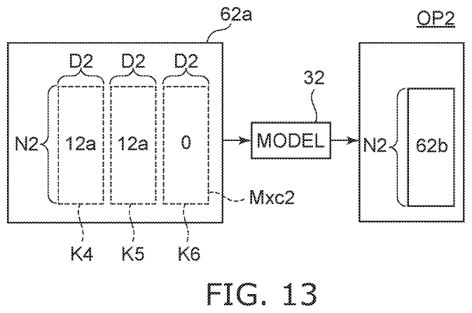

FIG. 13 is a schematic view illustrating the operation of the data processing device according to the first embodiment.

As shown in FIG. 13, the processor 71 can further derive a second regression label 62b by inputting a second regression matrix 62a to the second machine learning model 32 in the second operation OP2.

The second regression matrix 62a has N2 rows and (3×D2) columns. The second regression matrix 62a includes fourth regression matrix data K4, fifth regression matrix data K5 and sixth regression matrix data K6. The components of the fourth regression matrix data K4 include the second feature value matrix 12a. The components of the fifth regression matrix data K5 include the second feature value matrix 12a. The components of the sixth regression matrix data K6 include a matrix Mxc2 of 0 components with N2 rows and D2 columns (that is, 0 matrix). The second regression label 62b derived has N2 rows.

High accuracy is obtained in the second regression label 62b thus obtained. For example, the accuracy in the second regression label 62b is high. For example, in the first reference example, a machine learning model based on the second acquired data 12 (target data) is used. In the first reference example, the accuracy of regression labels obtained using this machine learning model is low. In the embodiment, the second regression label 62b with higher accuracy than the first reference example is obtained.

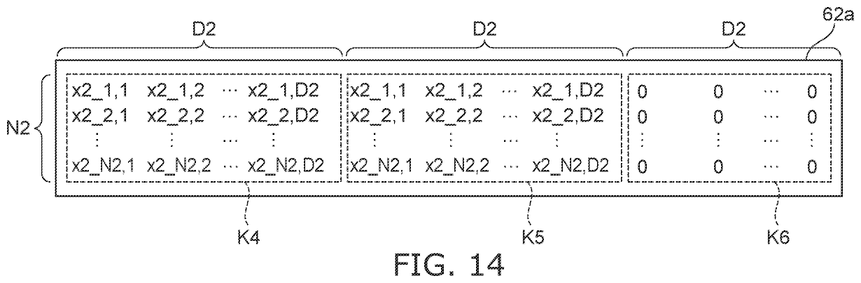

FIG. 14 is a schematic view illustrating the operation of the data processing device according to the first embodiment.

FIG. 14 illustrates the second regression matrix 62a. The first row of the second regression matrix 62a includes, for example, x2_14; x2_1,2; . . . x2_1,D2; x2_14; x2_1,2; . . . x2_1,D2; D2 “0”s. The second row of the second regression matrix 62a includes, for example, x2_24; x2_2,2; . . . x2_2,D2; x2_2,1; x2_2,2; . . . x2_2,D2; D2 “0”s. The N2-th row of the second regression matrix 62a includes, for example, x2_N1,1; x2_N1,2; . . . x2_N2,D2; x2_N2,1; x2_N2,2; . . . x2_N2,D2; D2 “0”s. Such second regression matrix 62a is input to the second machine learning model 32 to obtain the second regression label 62b.

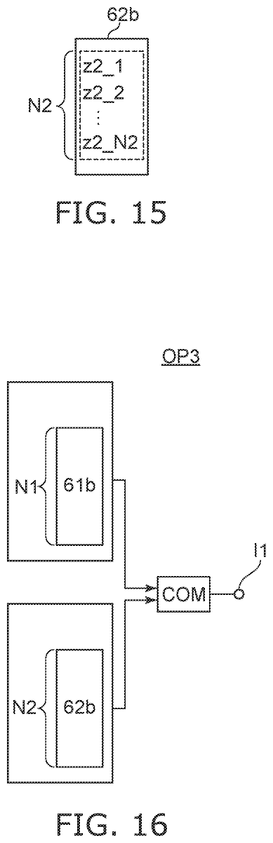

FIG. 15 is a schematic view illustrating the operation of the data processing device according to the first embodiment.

FIG. 15 illustrates the second regression label 62b. As shown in FIG. 15, the second regression label 62b includes, for example, z2_1; z2_2; . . . z2_N2. Such second regression label 62b has high accuracy.

The processor 71 may be able to perform the third operation.

FIG. 16 is a schematic view illustrating the operation of the data processing device according to the first embodiment.

As shown in FIG. 16, the processor 71 outputs information I1 regarding the comparison between the first regression label 61b and the second regression label 62b in the third operation OP3.

For example, the information I1 includes at least one of the first result or the second result. The first result includes a comparison result between the maximum value of the component of the first regression label 61b and the maximum value of the component of the second regression label 62b. The second result includes a comparison result of the minimum value of the component of the first regression label 61b and the minimum value of said component of the second regression label 62b.

For example, if the target device is a magnetic recording/reproducing device, the feature value includes a head width of a magnetic head. The label includes, for example, areal recording density. For example, the first regression label 61b includes multiple values relating to the areal recording density. The second regression label 62b includes multiple values relating to the areal recording density. For example, the maximum value of the multiple values included in the first regression label 61b and the maximum value of the multiple values included in the second regression label 62b are compared. The information I1 about the result of the comparison is output.

For example, the first acquired data 11 is data relating to a first trial. The second acquired data 12 is data relating to a second trial. The conditions in the second trial are different from the conditions in the first trial production. In the embodiment, the results of multiple trials can be evaluated with higher accuracy.

Examples of characteristics of the data processing device 110 according to the embodiment will be described below.

The following examples relate to areal recording densities for two types of magnetic recording/reproducing devices under different conditions. For each of the two conditions of the magnetic recording/reproducing device, a sufficiently large amount of data has already been obtained to enable accurate judgment. That is, the first mother data regarding the magnetic recording/reproducing device under the first condition and the second mother data regarding the magnetic recording/reproducing device under the second condition have already been obtained. Based on the first mother data and the second mother data, the superiority/inferiority (“actual ranking”) of the performance (in this example, areal recording density) with respect to the first condition and the second condition is known. These data are used experimentally to evaluate the performance of the data processing system.

Arbitrary data are extracted from the first mother data to obtain the first acquired data 11 for evaluation of the characteristics of the data processing device. The number of first acquired data 11 is smaller than the number of first mother data. On the other hand, arbitrary data is extracted from the second mother data to obtain the second acquired data 12. The number of second acquired data 12 is smaller than the number of second mother data.

In a first calculation example described below, the first generated data 21 is generated based on the first other data 51 and the first acquired data 11. Furthermore, the second generated data 22 is generated based on the second other data 52 and the second acquired data 12. The first other feature value matrix 51a, the first feature value matrix 11a, the second other feature value matrix 52a, and the second feature value matrix 12a are head widths of the magnetic head in the magnetic recording/reproducing device. The first other label 51b, the first acquired label 11b, the second other label 52b, and the second acquired label 12b are areal recording densities in the magnetic recording/reproducing device.

Furthermore, the first machine learning model 31 is derived. Furthermore, by inputting the first regression matrix 61a into the first machine learning model 31, the first regression label 61b is derived. The first regression label 61b thus obtained may not be accurate because the number of first acquired data 11 is smaller than the number of first mother data.

On the other hand, the second machine learning model 32 is derived. Furthermore, by inputting the second regression matrix 62a into the second machine learning model 32, the second regression label 62b is derived. The second regression label 62b thus obtained may not be accurate because the number of second acquired data 12 is smaller than the number of second mother data.

The superiority or inferiority of the first regression label 61b and the second regression label 62b is evaluated. When the superiority/inferiority evaluation result for the regression label is the same as the superiority/inferiority based on the first mother data and the second mother data, it corresponds to “correct answer”. If the superiority/inferiority evaluation result for the regression label is different from the superiority/inferiority based on the first mother data and the second mother data, it corresponds to “wrong answer”.

In the evaluation described below, the first ratio R1 (that is, (Np+N1)/D1) is changed to derive the “correct answer rate”. In the example below, “D1” is 1. “Nq” is the same as “Np”. “D2” is the same as “D1”. (Nq+N2)/D2 is the same as (Np+N1)/D1.

When the first ratio R1 is higher than 500, “N1” and “N2” are kept constant at 200, and the first ratio R1 is changed by changing “Np”. On the other hand, when the first ratio R1 is 500 or less, Np/N1 is kept constant at 1.5, and the first ratio R1 is changed by changing “Np” and “N1”.

On the other hand, in a second calculation example described below, a machine learning model based only on the first acquired data 11 and a machine learning model based only on the second acquired data 12 are used. In the second calculation example, the first other data 51 is not used and the second other data 52 is not used. In these calculation examples, the machine learning model is linear regression. Also in the second calculation example, the superiority/inferiority of the first regression label 61b and the second regression label 62b is evaluated, and the “percentage of correct answers” is calculated.

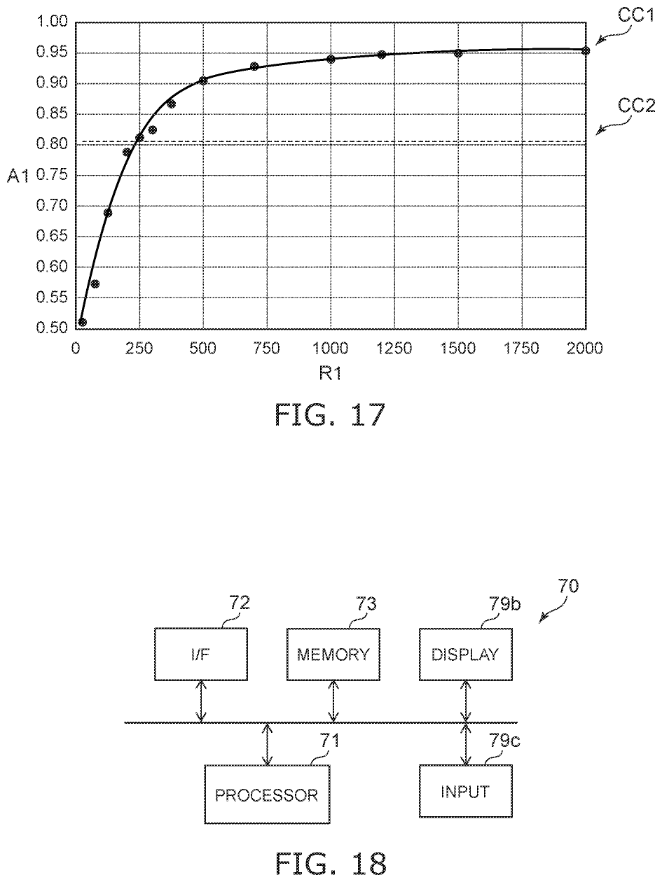

FIG. 17 is a graph illustrating characteristics of the data processing device according to the first embodiment.

FIG. 17 shows results of the first calculation example CC1 and the second calculation example CC2. As already described, in the first calculation example CC1, the first machine learning model 31 based on the first generated data 21 and the second machine learning model 32 based on the second generated data 22 are used by the above method according to the embodiment. On the other hand, in the second calculation example CC2, a machine learning model based only on the first acquired data 11 and a machine learning model based only on the second acquired data 12 are used. The second calculation example CC2 corresponds to the first reference example described above.

The horizontal axis of FIG. 17 is the first ratio R1. As already explained, the first ratio R1 is (Np+N1)/D1. The vertical axis in FIG. 17 is accuracy A1 for the derived first regression label 61b and second regression label 62b. The accuracy A1 corresponds to the correct answer rate of the calculated result rank relative to the actual rank. The rank corresponds to the superiority/inferiority of areal recording densities of the two types of magnetic recording/reproducing devices.

As shown in FIG. 17, in the second calculation example CC2, the accuracy A1 is 0.805. In the first calculation example CC1, the accuracy A1 increases as the first ratio R1 increases. In the first calculation example CC1, when the first ratio R1 is 250 or more, the accuracy A1 exceeds the accuracy A1 in the second calculation example CC2. In the first calculation example CC1, when the first ratio R1 is 500 or more, a high accuracy A1 of 0.9 or more is obtained.

In the embodiment, the first ratio R1 is preferably 250 or more. Thereby, a high accuracy A1 is obtained. More preferably, the first ratio R1 is 500 or more. A higher accuracy A1 is obtained.

For example, when comparing feature values under different conditions, as in the third operation OP3 described above, correct comparison is difficult if the accuracy A1 of the machine learning model is low. In the embodiment, by setting the first ratio R1 to be 250 or more (or, for example, 500 or more), feature values under different conditions can be compared with the high accuracy A1. For example, the first generated label 21b and the second generated label 22b can be compared and evaluated with high accuracy.

As described above, in the embodiment, a machine learning model based on the first generated data 21 in which the first acquired data 11 (target data) is combined with the first other data 51 is used. This provides higher accuracy than the first reference example, which uses a machine learning model based only on the target data.

For example, if the target device is a magnetic recording/reproducing device, the feature value is the head width of the magnetic head. In this case, the label may be, for example, areal recording density.

For example, when developing a target device, regression accuracy may be low if the number of samples is small. In the embodiment, even when the number of samples is small, the characteristics of development items can be evaluated with high accuracy.

In embodiments, Np/N1 is preferably 1.5 or more. High accuracy can be obtained even with a small “N1”.

In the embodiment, the first acquired data 11, the first other data 51, the second acquired data 12, and the second other data 52 may include characteristics of the magnetic recording/reproducing device.

Characteristics of the magnetic recording/reproducing device include, for example, at least one selected from the group consisting of SNR (Signal-Noise Ratio), BER (Bit Error Rate), Fringe BER, EWAC (Erase Width at AC erase), MWW (Magnetic Write track Width), OW (Over Write), SOVA-BER (Soft Viterbi Algorithm-BER), VMM (Viterbi Metric Margi), PRO (Repeatable RunOut), and NRRO (Non-Repeatable RunOut).

In the embodiment, “D1” may be one. For example, a high first ratio R1 is obtained. High-precision processing can be performed with a smaller “D1”.

In the data processing system 210 (see FIG. 1) according to the embodiment, multiple elements (for example, the processor 71 and the memory 73) may be provided at different locations. Information may be transmitted and received by any communication method. For example, multiple parts included in the processor 71 may be provided at different locations.

For example, data processing system 210 may include one or more acquisitors 72 and one or more processors 71. A part of the first operation OP1 may be performed by a part of one or more processors 71. Another part of the first operation OP1 may be performed by another part of the one or more processors 71. At least a part of the second operation OP2 or the third operation OP3 may be performed by another part of the one or more processors 71.

FIG. 18 is a schematic view illustrating the data processing device according to the embodiment.

As shown in FIG. 18, the data processing device 110 (processing device 70) includes the processor 71, the acquisitor 72 and the memory 73. The processor 71 is, for example, an electric circuit. The memory 73 may include, for example, at least one of ROM (Read Only Memory) or RAM (Random Access Memory). Any storage device may be used as the memory 73.

The data processing device 110 may include a display 79b and an input 79c. The display 79b may include various displays. The input 79c includes, for example, a device having an operation function (e.g., keyboard, mouse, touch input panel, voice recognition input device, etc.).

The embodiment may include a program. The program causes a computer (processor 71) to perform the above operations. The embodiment may include a storage medium storing the above program.

### Second Embodiment

The second embodiment relates to a data processing method. In the data processing method, the processor 71 is caused to perform the first operation OP1. The processor 71 can generate the first machine learning model 31 based on the first generated data 21 based on the first acquired data 11 and the first other data 51 in the first operation OP1.

The first other data 51 includes the first other feature value matrix 51a with Np rows and D1 columns and a first other label 51b with Np rows. “Np” is an integer of 2 or more. The first acquired data 11 includes a first feature value matrix 11a with N1 rows and D1 columns and a first acquired label 11b with N1 rows. “N1” is an integer of 2 or more. “D1” is an integer of 1 or more. “N1” is smaller than “Np”.

The first generated data 21 includes the first generated matrix 21a of (Np+N1) rows and (3×D1) columns and the first generated label 21b of (Np+N1) rows. The first generated matrix 21a includes first matrix data M1, second matrix data M2 and third matrix data M3.

The components of the first matrix data M1 include combinations in the row direction of the first other feature value matrix 51a and the first feature value matrix 11a. The components of the second matrix data M2 include combinations in the row direction of the matrix Mxa1 of 0 components with Np rows and D1 columns and the first feature value matrix 11a. The components of the third matrix data M3 include combinations in the row direction of the first other feature value matrix 51a and the matrix Mxb1 of 0 components with N1 rows and D1 columns.

The components of the first generated label 21b include the combination in the row direction of the first other label 51b and the first acquired label 11b. (Np+N1)/D1 is 250 or more. This ratio may be 500 or more.

The embodiment may include the following configurations (for example, technical proposals).

### Configuration 1

A data processing device, comprising:
an acquisitor; and
a processor,
the acquisitor being configured to acquire first acquired data in a first operation,
the processor being configured to generate a first machine learning model based on a first generated data based on the first acquired data and a first other acquired data in the first operation,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 rows, the N1 being an integer of 2 or more, the N1 being smaller than the Np,
the first generated data including a first generated matrix with (Np+N1) rows and (3×D1) columns and a first generated label with (Np+N1) rows,
the first generated matrix including first matrix data, second matrix data, and third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.

### Configuration 2

The data processing device according to Configuration 1, further comprising:
a memory,
the memory including a first memory area,
the first acquired data and the first other data being stored in the first memory area, and
the processor being configured to acquire the first acquired data and the first other data from the first memory area and perform the first operation.

### Configuration 3

The data processing device according to Configuration 2, wherein
the memory further includes a second memory area, and
the processor is configured to store the first generated data in the second memory area.

### Configuration 4

The data processing device according to any one of Configurations 1 to 3, wherein
the processor is configured to further derive a first regression label by inputting a first regression matrix to the first machine learning model in the first operation,
the first regression matrix has N1 rows and (3×D1) columns,
the first regression matrix includes first regression matrix data, second regression matrix data, and third regression matrix data,
components of the first regression matrix data includes the first feature value matrix,
components of the second regression matrix data include the first feature value matrix, and
components of the third regression matrix data include a matrix of 0 components with N1 rows and D1 columns.

### Configuration 5

The data processing device according to Configuration 4, wherein
the first regression label has the N1 rows.

### Configuration 6

The data processing device according to Configuration 4 or 5, wherein
the acquisitor and the processor are configured to further perform a second operation,
the acquisitor is configured to acquire a second acquired data in the second operation,
the processor is configured to generate a second machine leaning model based on a second generated data based on the second acquired data and the second other data,
the second other data includes a second feature value matrix with Nq rows and D2 columns and a second other label with Np rows, the Np is an integer of 2 or more, the D2 is an integer of 1 or more,
the second acquired data includes a second feature value matrix with N₂ rows and D2 columns and a second acquired label with Np rows, the N2 is an integer of 2 or more, the N2 is smaller than the Nq,
the second generated data includes a second generated matrix with (Nq+N2) rows and (D2×3) columns and a second generated label with (Nq+N2) rows,
the second generated matrix includes fourth matrix data, fifth matrix data, and sixth matrix data,
components of the fourth matrix data includes combinations in a row direction of the second other feature value matrix and the second feature value matrix,
components of the fifth matrix data includes combinations in the row direction of a matrix of 0 components with Nq rows and D2 columns and the second feature value matrix,
components of the sixth matrix data includes combinations in the row direction of the second other feature value matrix and a matrix of 0 components with N₂ rows and D2 columns,
components of the second generated label includes combinations in the row direction of the second other label and the second acquired label,
(Nq+N2)/D2 is 250 or more,
the processor is configured to further derive a second regression label by inputting a second regression matrix to the second machine learning model in the second operation,
the second regression matrix has N2 rows and (D2×3) columns,
the second regression matrix includes fourth regression matrix data, fifth regression matrix data, and sixth regression matrix data,
components of the fourth regression matrix data includes the second feature value matrix,
components of the fifth regression matrix data includes the second feature value matrix, and
components of the sixth regression matrix data include a matrix of 0 components with N₂ rows and D2 columns.

### Configuration 7

The data processing device according to Configuration 6, wherein
the processor is configured to further perform a third operation, and
the processor is configured to output information relating to comparison between the first regression label and the second regression label in the third operation.

### Configuration 8

The data processing device according to Configuration 7, wherein
the information includes at least one of a first result or a second result,
the first result includes a comparison result between a maximum value of components of the first regression label and a maximum value of components of the second regression label, and
the second result includes a comparison result between a minimum value of the components of the first regression label and a minimum value of the components of the second regression label.

### Configuration 9

The data processing device according to any one of Configurations 6 to 8, wherein
the second regression label has N2 rows.

### Configuration 10

The data processing device according to any one of Configurations 1 to 9, wherein
(Np+N1)/D1 is 500 or more.

### Configuration 11

The data processing device according to any one of Configurations 1 to 10, wherein
Np/N1 is 1.5 or more.

### Configuration 12

The data processing device according to any one of Configurations 1 to 11, wherein
the processor is configured to generate the first machine learning model by at least one selected from the group consisting of kernel regression, linear regression, Ridge regression, Lasso regression, Elastic Net, gradient boosting regression, random forest regression, k-nearest neighbor regression, and logistic regression.

### Configuration 13

The data processing device according to Configuration 12, wherein
the kernel regression includes at least one of Gaussian process regression or SVR (Support Vector Regression).

### Configuration 14

The data processing device according to any one of Configurations 1 to 13, wherein
the first acquired data, the first other data, and the second acquired data include characteristics of a magnetic recording/reproducing device.

### Configuration 15

The data processing device according to Configuration 14, wherein
the characteristics include at least one selected from the group consisting of SNR (Signal-Noise Ratio), BER (Bit Error Rate), Fringe BER, EWAC (Erase Width at AC erase), MWW (Magnetic Write track Width), OW (Over Write), SOVA-BER (Soft Viterbi Algorithm-BER), VMM (Viterbi Metric Margi), PRO (Repeatable RunOut), and NRRO (Non-Repeatable RunOut).

### Configuration 16

The data processing device according to any one of Configurations 1 to 15, wherein
the D1 is 1.

### Configuration 17

A data processing system, comprising:
one or a plurality of acquisitors;
one or a plurality of processors,
the one or plurality of acquisitors being configured to acquire a first acquired data in a first operation,
the one or plurality of processors being configured to generate a first machine learning model based on a first generated data based on the first acquired data and a first other data,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 columns, the N1 being an integer of 2 or more, the N1 being smaller than the Np,
the first generated data including a first generated matrix with (Np+N1) rows and (3×D1) columns and a first generated label with (Np+N1) rows,
the first generated matrix including a first matrix data, a second matrix data, and a third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.

### Configuration 18

The data processing system according to Configuration 17, wherein
a part of the first operation is performed by a part of the one or plurality of processors, and
another part of the first operation is performed by another part of the one or plurality of processors.

### Configuration 19

A data processing method, a processor being caused to perform a first operation in the data processing method,
the processor being configured to generate a first machine learning model based on a first generated data based on the first acquired data and a first other acquired data in the first operation,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 rows, the N1 being an integer of 2 or more, the N1 being smaller than the Np,
the first generated data including a first generated matrix with (Np+N1) rows and (3×D1) columns and a first generated label with (Np+N1) rows,
the first generated matrix including first matrix data, second matrix data, and third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.

According to the embodiments, it is possible to provide a data processing device, a data processing system, and a data processing method, in which high accuracy data processing is possible.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in data processing devices, data processing systems, and data processing methods such as processors, acquisitors, memories, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all data processing devices, data processing systems, and data processing methods practicable by an appropriate design modification by one skilled in the art based on the data processing devices, the data processing systems, and the data processing methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A data processing device, comprising:
an acquisitor; and
a processor,
the acquisitor being configured to acquire first acquired data in a first operation,
the processor being configured to generate a first machine learning model based on a first generated data based on the first acquired data and a first other acquired data in the first operation,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 rows, the N1 being an integer of 2 or more, the N1 being smaller than the Np,
the first generated data including a first generated matrix with (Np+N1) rows and (3×D1) columns and a first generated label with (Np+N1) rows,
the first generated matrix including first matrix data, second matrix data, and third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.

2. The device according to claim 1, further comprising:
a memory,
the memory including a first memory area,
the first acquired data and the first other data being stored in the first memory area, and
the processor being configured to acquire the first acquired data and the first other data from the first memory area and perform the first operation.

3. The device according to claim 2, wherein
the memory further includes a second memory area, and
the processor is configured to store the first generated data in the second memory area.

4. The device according to claim 1, wherein
the processor is configured to further derive a first regression label by inputting a first regression matrix to the first machine learning model in the first operation,
the first regression matrix has N1 rows and (3×D1) columns,
the first regression matrix includes first regression matrix data, second regression matrix data, and third regression matrix data,
components of the first regression matrix data includes the first feature value matrix,
components of the second regression matrix data include the first feature value matrix, and
components of the third regression matrix data include a matrix of 0 components with N1 rows and D1 columns.

5. The device according to claim 4, wherein
the first regression label has the N1 rows.

6. The device according to claim 4, wherein
the acquisitor and the processor are configured to further perform a second operation,
the acquisitor is configured to acquire a second acquired data in the second operation,
the processor is configured to generate a second machine leaning model based on a second generated data based on the second acquired data and a second other data,
the second other data includes a second feature value matrix with Nq rows and D2 columns and a second other label with Np rows, the Np is an integer of 2 or more, the D2 is an integer of 1 or more,
the second acquired data includes a second feature value matrix with N₂ rows and D2 columns and a second acquired label with Np rows, the N2 is an integer of 2 or more, the N2 is smaller than the Nq,
the second generated data includes a second generated matrix with (Nq+N2) rows and (D2×3) columns and a second generated label with (Nq+N2) rows,
the second generated matrix includes fourth matrix data, fifth matrix data, and sixth matrix data,
components of the fourth matrix data includes combinations in a row direction of the second other feature value matrix and the second feature value matrix,
components of the fifth matrix data includes combinations in the row direction of a matrix of 0 components with Nq rows and D2 columns and the second feature value matrix,
components of the sixth matrix data includes combinations in the row direction of the second other feature value matrix and a matrix of 0 components with N₂ rows and D2 columns,
components of the second generated label includes combinations in the row direction of the second other label and the second acquired label,
(Nq+N2)/D2 is 250 or more,
the processor is configured to further derive a second regression label by inputting a second regression matrix to the second machine learning model in the second operation,
the second regression matrix has N2 rows and (D2×3) columns,
the second regression matrix includes fourth regression matrix data, fifth regression matrix data, and sixth regression matrix data,
components of the fourth regression matrix data includes the second feature value matrix,
components of the fifth regression matrix data includes the second feature value matrix, and
components of the sixth regression matrix data include a matrix of 0 components with N2 rows and D2 columns.

7. The device according to claim 6, wherein
the processor is configured to further perform a third operation, and
the processor is configured to output information relating to comparison between the first regression label and the second regression label in the third operation.

8. The device according to claim 7, wherein
the information includes at least one of a first result or a second result,
the first result includes a comparison result between a maximum value of components of the first regression label and a maximum value of components of the second regression label, and
the second result includes a comparison result between a minimum value of the components of the first regression label and a minimum value of the components of the second regression label.

9. The device according to claim 6, wherein
the second regression label has N2 rows.

10. The device according to claim 1, wherein
(Np+N1)/D1 is 500 or more.

11. The device according to claim 1, wherein
Np/N1 is 1.5 or more.

12. The device according to claim 1, wherein
the processor is configured to generate the first machine learning model by at least one selected from the group consisting of kernel regression, linear regression, Ridge regression, Lasso regression, Elastic Net, gradient boosting regression, random forest regression, k-nearest neighbor regression, and logistic regression.

13. The device according to claim 12, wherein
the kernel regression includes at least one of Gaussian process regression or SVR (Support Vector Regression).

14. The device according to claim 1, wherein
the first acquired data, the first other data, and the second acquired data include characteristics of a magnetic recording/reproducing device.

15. The device according to claim 14, wherein
the characteristics include at least one selected from the group consisting of SNR (Signal-Noise Ratio), BER (Bit Error Rate), Fringe BER, EWAC (Erase Width at AC erase), MWW (Magnetic Write track Width), OW (Over Write), SOVA-BER (Soft Viterbi Algorithm-BER), VMM (Viterbi Metric Margi), PRO (Repeatable RunOut), and NRRO (Non-Repeatable RunOut).

16. The device according to claim 1, wherein
the D1 is 1.

17. A data processing system, comprising:
one or a plurality of acquisitors;
one or a plurality of processors,
the one or plurality of acquisitors being configured to acquire a first acquired data in a first operation,
the one or plurality of processors being configured to generate a first machine learning model based on a first generated data based on the first acquired data and a first other data,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 columns, the N1 being an integer of 2 or more, the N1 being smaller than the Np,
the first generated data including a first generated matrix with (Np+N1) rows and (3×D1) columns and a first generated label with (Np+N1) rows,
the first generated matrix including a first matrix data, a second matrix data, and a third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.

18. The system according to claim 17, wherein
a part of the first operation is performed by a part of the one or plurality of processors, and
another part of the first operation is performed by another part of the one or plurality of processors.

19. A data processing method, a processor being caused to perform a first operation in the data processing method,
the processor being configured to generate a first machine learning model based on a first generated data based on the first acquired data and a first other acquired data in the first operation,
the first other data including a first other feature value matrix with Np rows and D1 columns and a first other label with Np rows, the Np being an integer of 2 or more, the D1 being an integer of 1 or more,
the first acquired data including a first feature value matrix with N1 rows and D1 columns and a first acquired label with N1 rows, the N1 being an integer of 2 or more, the N1 being smaller than the Np,
the first generated data including a first generated matrix with (Np+N1) rows and (3×D1) columns and a first generated label with (Np+N1) rows,
the first generated matrix including first matrix data, second matrix data, and third matrix data,
components of the first matrix data including combinations in a row direction of the first other feature value matrix and the first feature value matrix,
components of the second matrix data including combinations in the row direction of a matrix of 0 components with Np rows and D1 columns and the first feature value matrix,
components of the third matrix data including combinations in the row direction of the first other feature value matrix and a matrix of 0 components with N1 rows and D1 columns,
components of the first generated label including combinations in the row direction of the first other label and the first acquired label, and
(Np+N1)/D1 being 250 or more.
